(19) United States
(12) Patent Application Publication
(10) Pub. No.: US 2021/0053153 A1
(43) Pub. Date: Feb. 25, 2021

(54) METHOD FOR JOINING TWO COMPONENTS TO ONE ANOTHER BY MEANS OF LASER WELDING AND COMPONENT ARRANGEMENT

(71) Applicant: WLLT GMBH, Ispringen (DE)

(72) Inventor: Reiner WAGNER, Ispringen (DE)

(73) Assignee: WLLT GMBH, Ispringen (DE)

(21) Appl. No.: 16/971,708

(22) PCT Filed: Feb. 20, 2019
(86) PCT No.: PCT/EP2019/054248

§ 371 Date: Sep. 11, 2020

(30) Foreign Application Priority Data
Feb. 23, 2018 (DE) 10 2018 202 810.9
Feb. 28, 2018 (DE) 10 2018 202 997.0
May 9, 2018 (DE) 10 2018 207 322.8
Sep. 19, 2018 (DE) 10 2018 215 985.8

(51) Int. Cl. B23K 26/242; B23K 26/26

(52) U.S. Cl. CPC B23K 26/242; B23K 2103/05; B23K 26/26

(57) ABSTRACT

The invention relates to a method for joining two components to one another by laser welding, wherein a first component and a second component are arranged adjacent to one another to form a component arrangement, in that the component arrangement has an irradiation surface which has a first radiation partial surface on the first component and a second radiation partial surface on the second component, wherein the irradiation surface is irradiated with a laser beam along an irradiation direction in a joining region. In the method, the irradiation surface has a gap in the joining region, the gap extending from the irradiation surface in the irradiation direction, wherein the first component and the second component are joined to one another by heat conduction welding.

The invention relates to a method for joining two components with one another by laser welding and a component arrangement of two components joined with one another by means of laser hot wire welding.

For the joining of components by laser welding, essentially two methods are known, which are distinguished from each other on a scale of the power density of the laser radiation used. There is the first method of the so-called heat conduction welding, also known as heat conduction seam welding. This method is given at power densities up to 10⁵ W/cm². In this method, a surface of the components to be joined is heated up so much that a locally limited melting method begins. The energy absorbed by the components passes through Heat conduction to the inside of the component. A weld seam formed by heat conduction welding typically has—when seen in cross section or micrograph—a lenticular seam geometry with a low aspect ratio, whereby a seam depth is typically smaller, but at most the same size as a seam width. If the power density at the surface of the components is increased to a magnitude of some 10⁵ W/cm² up to some 10⁶ W/cm2, a strong evaporation process will start. A vapor capillary is formed, which is essential for the reflection and absorption behavior of the laser radiation. Due to the vapor capillary, a substantial part of the irradiated energy is coupled into the joint region. Furthermore, the laser radiation can penetrate much deeper into the components to be joined due to the vapor capillary, which is why the term “deep welding” is deployed for this welding method. Laser welds formed by deep penetration have an aspect ratio of greater than 1, typically greater than 2, where the seam depth is more than twice the seam width.

The problem with the deep welding method is that materials sensitive to oxidation cannot be reliably welded, since they form oxides due to the formation of a vapor capillary, which contribute to the protrusion and thus to the emergence of strength in the formed laser weld seam.

Due to the high power coupled into the joint region, spraying occurs, which often prevents the formation of a smooth weld seam and contributes to the formation of pores. In addition, in the method of deep welding, metal vapor is generated, which can be deposited in the vicinity of the laser weld. On the one hand, this is problematic for aesthetic reasons, on the other hand can lead to leakage currents or short circuits when welding electrical or electronic components. Furthermore, it proves to be difficult to weld components made of different materials with one another. Gas-tight welds are hardly possible, especially when using oxidation-sensitive materials, due to the seam spalling. Especially problematic is the application of this welding method to sintered components, which are produced, for example, by additive or metal injection molding (MIM). In the production of such components, it cannot be completely ruled out that residual amounts of organic binder material are present, which are mixed with the metal powder and are important for forming the green part in metal powder injection molding, which then, due to the high laser power during deep penetration welding, outgas, oxidize and form residues which strongly impair the aesthetic appearance of the welded components. In addition, the oxidation products of the residual binder also lead to the weld seam becoming brittle, so that no stable, gas-tight welding can be obtained. Sintered components also typically have pores in their interior that can be filled with gas. This gas can also be chemically altered in the laser welding method, in particular it can react with the material of the sintered component and/or be deposited on the surface, which can result in an aesthetic and/or mechanical impairment of the weld. Also the creation of a welding seam with well-defined seam depth is hardly possible in the method of deep welding, because the seam depth is hardly controllable. Furthermore, thin-walled, especially precision-mechanical components can hardly be welded with one another in the method of deep welding. This is due to the fact that the seam depth is hardly controllable and therefore there is a risk of welding through and destroying the components or the resulting component composite.

However, the method of heat conduction welding also has disadvantages: The fact that only comparatively flat weld seams can be produced, whose depth can hardly be influenced, no stable connection between two components can be achieved in this method either, which is durable even under high pressure and is gas-tight, especially under such conditions.

It has been proposed to influence, in particular to increase the seam depth in hot conduction welding by a filler material, by adjusting the temperature at the weld pool surface and by adding method gases (R. Daub, “Erhöhung der Nahttiefe beim Laserstrahl-Warmleiteschweiβen von Stahlen”, Dissertation, Fakultat für Maschinenwesen, Technische Universitat Munchen, 2012). However, as far as it is practicable, these measures do not allow a sufficient increase of the seam depth and/or exact geometric adjustment of the seam depth. The invention is based on the task of creating a method for joining two components with one another by laser welding as well as a component arrangement with two components, whereby the disadvantages mentioned above do not occur.

The task is solved by creating the objects of the independent claims. Advantageous designs result from the sub claims.

The task is solved in particular by creating a method for joining two components with one another by laser welding, whereby a first component and a second component are arranged adjacent to each other in a component arrangement in such a way that the part arrangement has an irradiation surface which has a first irradiation sub-surface on the first part and a second irradiation sub-surface on the second part. The irradiation surface is irradiated with a laser beam along an irradiation direction in a joint region. The irradiation direction corresponds in particular to the direction of propagation or propagation of the laser beam. It is intended that the irradiation surface in the joint region has a gap that narrows in the direction of irradiation starting from the irradiation surface. At the same time the first component and the second component are joined with one another by Heat conduction welding. By providing the irradiation surface with a gap in the joint region, it is possible to influence the conditions of the laser weld seam formation even in the method of heat conduction welding so that the seam geometry of the laser weld seam is adjustable. In particular, the geometry of the laser weld seam in cross section or micrograph can be largely determined or specified by the geometry of the gap. Thus, it is possible to form very stable weld seams in the method of heat conduction welding by means of the gap tapering from the irradiation surface in the direction of irradiation, which in particular can also have a depth that is greater than their width.

The laser radiation melts material from the walls of the gap, especially by forming multiple reflections of the laser radiation in the gap and fills the gap from below, i.e. from the side of the gap that is turned away from the irradiation surface. Thus, the depth of the resulting weld seam in particular is essentially determined/adjusted geometrically by the design of the gap tapering in the direction of irradiation. The welding depth can be determined by the geometry of the gap.

The method is particularly suitable for welding diaphragm-walled components with one another. This results in particular from the fact that the depth of the welding seam can be well defined, so that there is no danger of welding through, while on the other hand a stable, firm and in particular also pressure-tight connection of the components with each other can be created.

The irradiation direction is preferably chosen parallel to a center plane or symmetry plane of the gap. Preferably, the irradiation direction is in the center plane or plane of symmetry. If the partial irradiation surfaces are aligned with each other, the Irradiation direction is preferably vertical on the irradiation surface.

The walls of the gap are preferably partial surfaces of the irradiation surface.

Due to the multiple reflections occurring in the gap, considerably more energy can be introduced than would be possible when irradiating the irradiation surface without the gap. This contributes to the formation of more stable and/or deeper weld seams, also in the region of heat conduction welding. Thus, the welds produced in this way have all the properties and advantages of welds produced in the method of heat conduction welding, namely a smooth surface, high ductility, freedom from spatter, metal vapor and pores, avoidance of oxide formation during formation, and many more, while at the same time very stable, gas-tight and pressure-tight welds can be formed, which in particular also may have greater depth than their width. Ductile, tough welded joints are formed, which are free of embrittlement especially due to oxides.

It is also possible to weld different joint partners with one another in the method of heat conduction welding. It is also possible to weld thin-walled components, especially with wall thicknesses of 0.1 mm to 4 mm, preferably 0.2 mm to 3 mm, to each other or to thicker-walled components without fear of welding through and thus damaging the components.

Sintered components, in particular components manufactured with additives or those manufactured in a metal powder injection moulding method, can be joined without difficulty using the method proposed here, since residual binder components do not oxidise and thus do not contribute to seam deformation, nor do unfriendly deposits of oxidation products or residual gases from pores build up.

It is important that laser welding in the procedure proposed here is carried out in the method of heat conduction welding. The power density is preferably less than 10⁶ W/cm², preferably less than 8.10⁵ W/cm², preferably less than 6.10⁵ W/cm², preferably less than 5.10⁵ W/cm², preferably less than 4.10⁵ W/cm², preferably less than 3.10⁵ W/cm², preferably less than 2.10⁵ W/cm², preferably less than 10⁵ W/cm², preferably less than 8.10⁴ W/cm², preferably less than 6.10⁴ W/cm², preferably less than 5.10⁴ W/cm². In particular, the power density is selected in such a way that heating of the component assembly above the evaporation temperature of the component with the lower evaporation temperature or above the evaporation temperature of both components is avoided.

A cross-section is understood to be a view that lies in a plane in which the irradiation direction is arranged as intended, whereby a longitudinal direction of the gap and also of the formed laser weld seam extends perpendicular to this plane. The cross-sectional plane is therefore also a plane in which micrographs are usually produced in order to be able to assess the quality of the weld and especially the laser weld seam.

Preferably, at least one thin-walled component is used as the first component and/or as the second component, whereby the wall thickness of at least one thin-walled component, is preferably from at least 0.1 mm up to at most 4 mm, preferably from at least 0.2 mm up to at most 3 mm. A thin-walled component is particularly preferred both as the first component and as the second component, especially with such a wall thickness, so that at least two thin-walled components are welded with one another with particular preference. The present method is particularly suitable for Welding in the field of precision engineering, especially for welding precision mechanical components with one another.

At least one component, selected from the first component and the second component, is preferably formed as sheet metal. At least one component is selected from the first component and the second component, preferably in the form of a wire.

Alternatively or additionally at least one component selected from the first component and the second component is preferably formed as a rotationally symmetrical component, in particular as a shaft, axle, tube or the same. With the method proposed here, it is possible to join not just sheet metal components with one another, but also wire components can be joined with one another. A component in the form of a sheet can also be joined with a component in the form of a wire. Due to their round geometry, wires among themselves—or a wire in contact with a sheet—form a line contact with the adjacent component, which quasi forms the bottom of the gap, which is then the irradiation surface. In particular, two wires arranged side by side along their longitudinal extension, which are in particular in contact with each other, and which are irradiated with laser radiation perpendicular to their longitudinal extension, thus have a gap due to their round geometry, which tapers from the irradiation surface in the direction of irradiation. When welding such wires—or an arrangement of a wire and a sheet metal—using the method proposed here, it has been found that the material melted off the walls of the gap fills the gap very efficiently, but not on the side of the workpiece facing away from the irradiation surface wherein the gap exits from it. Thus, even such a fragile arrangement is not welded through, but rather a clean, stable weld is produced, whereby the connected components also have an aesthetically gritty appearance from a side facing away from the weld, since no welding material escapes and in particular no splashes reach it. In particular, an optical quality like that of a soldered seam can be achieved. Rotationally symmetrical components can be welded with the method proposed here, especially along a circumferential line—especially all around the entire circumference. It is preferably possible that both components are designed as rotationally symmetric components.

The irradiation surface can be flat. However, it is also possible that the irradiation region is not flat or only partially flat. The irradiation surface is therefore not necessarily a plane. In particular, it is possible that the first partial irradiation surface encloses an angle with the second partial irradiation surface, especially if the first and the second part are butt-jointed at an angle.

Preferably, the first and the second partial irradiation surface are separated by a gap in the joint region.

In the joint region, the components to be joined are preferably adjacent to each other, or at least next to each other or adjacent to each other.

It is possible that the first component and the second component are arranged directly adjacent to each other, in particular they are placed against each other so that they touch each other. However, it is also possible that there is a distance between the first component and the second component, in particular small distances of at most 0.3 mm can be bridged in laser welding with the method proposed here. In particular, distances between the first component and the second component of the order of magnitude mentioned can be bridged by the method proposed here, since the material melted from the walls of the gap forms droplets which flow into the narrowing gap and close it from below. The melted material solidifies before it can emerge from the gap on the opposite side. The distance discussed here is in particular a smallest distance between the first component and the second component, which can be given in particular in the bottom of the gap.

In the context of the procedure proposed here, welding through the gap or through the gap is specifically avoided.

According to a further development of the invention, it is provided that the component arrangement is provided by arranging the first component and the second component at a distance from each other which is from at least 0 mm to at most 0.3 mm, preferably to at most 0.25 mm, preferably to at most 0.2 mm, preferably at least 0.01 mm, preferably at least 0.02 mm, preferably at least 0.05 mm, preferably to at most 0.1 mm. This distance is measured especially in the joint region. If the distance is 0 mm, the components lie directly against each other. However, it is also possible that the components cannot be arranged at the same distance from each other along the entire length of the joint region, either because the surfaces are not completely parallel or because the components are bent in at least one direction.

In this case, different distances can arise along the joint region—especially along the extension of the weld seam to be formed—which can lie in particular in the regions mentioned here, whereby the distance can vary especially in the regions mentioned. As already emphasized, such distances can easily be bridged during laser welding with the method proposed here.

Especially preferred are the components which are joined with one another without any filler material, i.e. no filler material is used in laser welding, whereas a distance of the mentioned order of magnitude can be bridged in laser welding with the method proposed here without any problems on the basis of the previously explained mechanism without filler material.

In particular, the first component and the second component are arranged adjacent to each other with a distance in the mentioned regions, whereby in this way the component arrangement is obtained.

According to a further development of the invention, it is provided that a minimum distance between the first component and the second component be of at least 0 mm up to at most 0.3 mm, preferably up to at most 0.25 mm, preferably up to at most 0.2 mm, preferably at least 0.01 mm, preferably at least 0.02 mm, preferably at least 0.05 mm, preferably at most 0.1 mm. The minimum distance is preferably measured in the joint region. The minimum distance represents in particular a shortest or smallest distance between the first component and the second component, especially in the joint region. The minimum distance is therefore preferably set specifically. As already mentioned, distances in the orders of magnitude or regions mentioned here can easily be bridged by laser welding within the scope of the procedure proposed here. No filler material is particularly preferred, the first component and second component are thus joined with one another, especially without an additional material.

The terms “gap” and “distance” are used here especially as follows: The gap is formed in the region of the joint and becomes narrower starting from the irradiation surface, so that a distance measured in the region of the gap between the first component and the second component decreases starting from the irradiation surface in the direction of irradiation. The distance is now the distance between the components that is minimum in the region of the gap in the irradiation direction, in particular the distance at the end or foot of the gap, or a distance which is measured below the gap in the irradiation direction, i.e. away from the irradiation surface. The term “gap” thus refers to a certain geometrical structure of the component arrangement, while the term “distance” refers to a certain distance between the first component and the second component, which is measured at a certain height, in particular—seen in the irradiation direction—preferably at the foot of the gap or the irradiation surface facing away from the gap.

According to a further development of the invention, the components are joined with one another without the use of a filler material. In particular, welding, in particular laser welding, in particular heat conduction welding, is performed without filler material. In the method proposed here, the use of a filler material can be dispensed with in an advantageous way. This is especially advantageous for welding of precision mechanical components, especially if they have thicknesses in the range of a few tenths of a millimeter, especially from 0.1 mm to 4 mm, preferably from 0.2 mm to 3 mm.

Alternatively or additionally it is intended that the first component and the second component are joined with one another without inert gas. With the method disclosed here, it is advantageously possible to produce oxide-free, ductile, tough, stable and especially to create pressure-tight welding seams.

According to a further development of the invention, it is provided that the quotient of a beam-width dimension of the laser beam to a width of the gap measured in the irradiation surface is at least 0.2 to at most 2.0. It has been found that in this range of the quotient particularly favorable results are obtained with regard to a stable weld seam. If the laser beam has a Gauss-shaped beam profile, the beam width dimension is preferably measured in a plane perpendicular to the direction of irradiation where the intensity of the laser beam is still a factor 1/e² of the intensity of the laser beam on the axis, i.e. in the intensity maximum of the Gaussian profile. If the laser beam has a rectangular profile, the beam width is defined by the rectangular profile. It is also possible that the laser beam can be reduced by suitable beam apertures or beam shaping is formed or blanked. In this case, the laser beam also has a beam width dimension determined by the aperture diameter.

A beam width measurement here refers in particular to a beam width measured perpendicularly to a feed direction along a longitudinal extension of the weld seam being produced in the cross-section of the laser beam. For a circular beam cross section, the beam width measure is in particular a beam diameter. For the sake of simplicity, the terms “beam width” and “beam diameter” are used synonymously in the following without regard to the concrete shape or profile of the laser beam in cross section.

According to a further development of the invention, it is provided that the quotient of the beam width dimension to the width of the gap is from at least 0.3 to at most 2.0; preferably from 0.4 to at most 2.0; preferably from at least 0.5 to at most 2.0; preferably from at least 0.6 to at most 1.9; preferably from at least 0.7 to at most 1.8; preferably to at most 1.7; preferably to at most 1.6; preferably from at least 0.8 to at most 1.5; preferably from at least 0.9 to at most 1.4; preferably from at least 1.0 to at most 1.3; preferably 1.2. It turned out that in the regions defined here there are particularly favorable conditions for the formation of a stable laser weld seam within the framework of the procedure proposed here.

According to a development of the invention it is provided that the gap is provided symmetrically on the first component and on the second component. In this case, the component arrangement from the first component and the second component preferably has a plane of symmetry extending between the components, the entire gap geometry being mirrored by mirroring the geometry of the first component in the region of the gap on the plane of symmetry—or vice versa by mirroring the geometry of the second component at the plane of symmetry.

Alternatively, it is possible that the gap is asymmetrically provided at the first component and at the second component, whereby the walls of the gap may differ at the components especially with respect to their curvature and/or their angle to the irradiation surface.

Alternatively it is possible that the gap is formed on one side of a component, selected from the first component and the second component. It is therefore possible that one of the components does not have a gap geometry, for example no chamfer or rounding or the like, but is rectangular or right-angled when viewed in cross-section. The other component may then have a chamfer or rounding, for example, so that the gap is formed in the joint region.

By choosing a certain geometry for the gap, the geometry of the resulting laser weld seam can be determined, which preferably also determines its properties.

According to a further development of the invention, the gap must have at least one rounded wall. An example for such a rounded wall is given by a wire, which has a round geometry—seen in cross-section. Two wires placed next to each other or a wire placed on a metal sheet thus have a gap with a rounded wall due to their own geometry. Especially preferred is the gap two rounded walls. This is the case, for example, with two wires arranged side by side along their longitudinal direction, with two sheets arranged side by side with rounded edges, or even with a sheet with a rounded edge next to which a wire is arranged.

Alternatively or additionally, it is possible that the gap has at least one flat sloping wall. This is possible, for example, if at least one of the components in the joint region has a bevel or other chamfer. Preferably the gap has two sloping walls. This is especially possible if both adjacent components have a bevel or chamfer in the joining region.

In this respect, the specific selection of a geometry for the gap has a significant influence on the properties of the laser weld seam formed, especially on its geometric properties. Preferably, at least one sheet with rounded edges is used as the at least one first and/or second component.

A gap, which has two flat sloping walls, is preferably triangular in cross-section.

According to a development of the invention, it is provided that the at least one rounded wall has a radius of at least 0.1 mm to at most 5 mm; preferably from at least 0.3 mm to at most 5 mm; preferably up to 4.5 mm at most, preferably up to 4 mm at most; preferably up to at most 3.5 mm; preferably up to at most 3 mm; preferably up to at most 2.7 mm; preferably from at least 0.4 mm to at most 2.6 mm; preferably from at least 0.5 mm to at most 2.5 mm; preferably from at least 0.6 mm to at most 2.4 mm; preferably from at least 0.7 mm to at most 2.3 mm; preferably from at least 0.8 mm to at most 2.2 mm; preferably from at least 0.9 mm to at most 2.1 mm; preferably from at least 1.0 mm to at most 2.0 mm; preferably from at least 1.1 mm to at most 1.9 mm; preferably from at least 1.2 mm to at most 1.8 mm; preferably from at least 1.3 mm to at most 1.7 mm; preferably from at least 1.4 mm to at most 1.6 mm; preferably 1.5 mm, preferably 0.65 mm. It has been found that with the radii defined here for the at least one rounded wall, preferably for the two rounded walls of the gap, particularly favorable conditions exist for the formation of a stable laser weld seam in the heat conduction seam welding method, with weld seams being able to be formed at the same time, which preferably have a depth that is greater than width of the irradiation region measured.

As an alternative or in addition, it is preferably provided that a full opening angle of the gap having at least one inclined wall of at least 15° to at most 60°; preferably from at least 20° to at most 55°; preferably from at least 30° to at most 45°; preferably from at least 35° to at most 40°; preferably 37°. A full opening angle is understood to mean an angle that overlaps the entire gap in the cross-sectional plane, that is to say extends from one wall of the gap to the opposite wall of the gap. It has been found that the angle ranges proposed here are particularly suitable for obtaining a stable laser weld seam in the heat conduction welding method, the depth of which can in particular also be greater than its width measured in the irradiation region.

As an alternative or in addition, it is preferably provided that a quotient of an irradiation direction starting from the irradiation region divided by the width of the gap measured in the irradiation region of at least 0.2, preferably of at least 0.3, preferably of at least 0.5, preferably from at least 0.6 to at most 3.2; preferably from at least 0.7 to at most 3.1; preferably from at least 0.8 to at most 3.0; preferably from at least 0.9 to at most 2.9; preferably from at least 1.0 to at most 2.8; preferably from at least 1.2 to at most 2.6; preferably from at least 1.4 to at most 2.4; preferably from at least 1.6 to at most 2.2; preferably from at least 1.8 to 10 at most 2.0; preferably 1.9. It has been found that, in particular, the ranges given here for the quotient of the depth of the gap to its width measured in the irradiation region make it possible to form a stable laser weld seam in the heat conduction welding method.

According to a further development of the invention it is provided that the laser beam is generated in a CW operation or continuous wave operation (CW—Continuous Wave). The laser beam is thus generated as a continuous laser radiation. With a continuous laser beam, particularly smooth and homogeneous laser weld seams can be produced.

Alternatively, it is possible for the laser beam to operate in a pulse mode, i.e. is generated as pulsed laser radiation. In this way, higher power densities can be generated particularly well.

It is preferably provided that the irradiation surface is irradiated by the laser beam in a clocked operation. In this case, a clocked operation can either be implemented by a continuous laser beam generated in CW operation through a Clocking device, for example a shutter, is chopped up over time and thus clocked, or that a pulsed laser beam is used. Of course, it is also possible to additionally clock a pulsed laser beam generated in pulsed operation by a clocking device, for example a shutter, for example to influence a clock frequency of the clocked operation. Particularly aesthetic weld seams can be produced in clocked operation.

In the clocked operation, a pulse length of at least 1 ms to at most 5 ms, preferably to at most 3 ms, is preferably generated for a clock or a single irradiation event of the irradiation surface.

Alternatively, it is preferably provided that the irradiation surface is irradiated with the laser beam in a continuous operation. For this purpose, a continuous laser beam generated in CW operation is preferably used, which is not timed by means of a clocking device.

As an alternative or in addition, provision is preferably made for the laser beam with a beam diameter of at least 0.1 mm to at most 2.5 mm; preferably up to at most 2 mm; preferably up to at most 1.5 mm; preferably up to at most 1 mm; preferably up to at most 0.9 mm; preferably from at least 0.2 mm to at most 0.8 mm; preferably from at least 0.3 mm to at most 0.7 mm; preferably from at least 0.4 mm to at most 0.6 mm; preferably 0.5 mm or 0.4 mm is produced. It has been found that particularly stable laser weld seams can be produced within the scope of the method proposed here for the beam diameter in the ranges specified here.

As an alternative or in addition, it is preferably provided that the laser beam has a power, especially averaged over time, of at least 50 W to at most 5 kW; preferably from at least 100 W to at most 5 kW; preferably up to at most 4.5 kW; preferably up to at most 4 kW; preferably up to at most 3.5 kW; preferably up to at most 3 kW; preferably up to at most 2.5 kW; preferably from at least 250 W to at most 2 kW, preferably from 750 W is generated. In particular, the power is matched to the beam diameter so that the power density is in the method of hot conduction welding.

As an alternative or in addition, provision is preferably made for the laser beam with a wavelength of at least 400 nm to at most 1200 nm, preferably from at least 920 nm to at most 1064 nm, in particular 532 nm or 515 nm or 450 nm, is generated. This wavelength range is particularly suitable for heat conduction welding, in particular of MIM components. The wavelength of the laser beam is preferably matched to the absorption of the material used for the components or the absorption of the materials of the components.

As an alternative or in addition, it is preferably provided that the laser beam is fed at a feed rate of at least 0.25 m/min, preferably of at least 0.5 m/min up to at most 30 m/min, preferably from at least 1 m/min to at most 25 m/min, preferably from at least 2 m/min to at most 20 m/min, preferably from at least 3 m/min to at most 17 m/min; preferably from at least 4 m/min to at most 16 m/min; preferably from at least 5 m/min to at most 15 m/min; preferably from at least 6 m/min to at most 14 m/min; preferably from at least 7 m/min to at most 13 m/min; preferably from at least 8 m/min to at most 12 m/min; preferably from at least 9 m/min to at most 11 m/min; is preferably displaced by 10 m/min or 12 m/min along the gap relative to the component arrangement. The feed rates mentioned here ensure the stable formation of a laser weld seam within the scope of the method proposed here. The laser beam is particularly preferred in clocked operation with a feed speed of at least 0.25 m/min, preferably from at least 0.5 m/min to at most 3 m/min, preferably up to at most 1 m/min, displaced along the gap relative to the component arrangement. As an alternative or in addition, the laser beam is preferably displaced in continuous operation at a feed rate of at least 3 m/min to at most 30 m/min along the gap relative to the component arrangement. In this way, the feed rate can advantageously be matched to the operating mode of the irradiation of the irradiation surface.

According to a further development of the invention, it is provided that the laser beam is generated by means of a laser selected from a group consisting of a diode laser, a fiber laser, an Nd: YAG laser, in particular a flash lamp-pumped Nd: YAG laser, and a disk laser, in particular a diode-pumped disk laser. The laser types proposed here have proven to be particularly suitable for producing stable laser weld seams within the scope of the method proposed here.

According to a further development of the invention it is provided that at least one component selected from the first component and the second component has at least one material or consists of a material selected from a group consisting of nickel silver, INOX, in particular INOX 316L, copper or a copper alloy, and titanium. Such components, in particular, can be welded within the scope of the method proposed here without the occurrence of oxidation products that adjoin the weld seam. The method proposed here is particularly suitable for these materials. According to a preferred design it is provided that the first component and the second component each have a material or consist of a material that is selected from the aforementioned group.

Particular advantages arise when applying the method disclosed here to a material that has copper or a copper alloy or is copper or a copper alloy. In particular, there are special advantages if a wavelength for the laser beam of 532 nm, 515 nm or 450 nm, generally a green or blue wavelength, is selected. Especially advantageous when welding copper and copper alloys are the multiple reflections in the gap resulting from the method. This extends the possibility of hot wire welding especially to greater seam depths. Furthermore, the method disclosed here is especially suitable for thin wall thicknesses.

According to a preferred design of the method, a spring hinge housing of a pair of spectacles, manufactured as a MIM component, is welded onto a frame which is made of INOX, in particular INOX 316L, or of INOX, in particular INOX 316L. In this case in particular, a weld seam can be obtained which has the optical appearance and/or quality of a soldered seam.

As an alternative or in addition, it is preferably provided that at least one component, selected from the first component and the second component, is produced as a sintered component. In the case of the method disclosed here, in particular residual gas quantities arranged in pores of the sintered component do not have a disadvantageous effect on the quality of the weld seam produced or the weld in general.

A sintered component is here in particular generally understood as a component that is produced by sintering, whereby in particular at least one method step in the production of the component is sinter or a sintering step.

In particular, it is preferably provided that at least one component, selected from the first component and the second component, is produced as an additively manufactured sinter component, for example by laser sintering.

Alternatively or additionally, it is preferred that at least one component selected from the first component and the second component is produced as a MIM component, i.e. by a metal injection molding (MIM) method. The advantages of the method are realized in a special way, since such components can be welded with the method proposed here without the risk of oxidation of residual binder components and the negative consequences resulting therefrom.

According to a preferred design, it is provided that both components, that is to say the first component and the second component, are manufactured as sintered components, in particular as additively manufactured sintered components or as MIM components. It is of course also possible that one of the components is manufactured as an additively manufactured sintered component and the other component of the components is manufactured as an MIM component.

According to a further development of the invention, it is provided that a laser weld seam is generated, with one of the irradiation surfaces perpendicular to the longitudinal extension of the laser weld seam measured width of the laser weld seam of at least 0.1 mm to at most 3 mm; preferably up to at most 2.5 mm; preferably up to at most 2 mm; preferably up to at most 1.5 mm; preferably up to at most 1 mm; preferably up to at most 0.9 mm; preferably from at least 0.2 mm to at most 0.8 mm; preferably at least 0.3 mm up to at most 0.7 mm; preferably from at least 0.4 mm to at most 0.6 mm; is preferably 0.5 mm or 0.4 mm. The laser weld seam is preferably produced as an elongated, drawn-out weld seam or a weld seam generated by overlapping, offset pulses along a curve, in particular a straight line, so that it has a longitudinal extension. The width of the laser weld seam becomes perpendicular to the longitudinal extension measured. With the widths measured here, stable weld seams that are gas-tight even under pressure can be formed.

Alternatively or in addition, it is preferably provided that the depth of the laser weld seam measured in an irradiation direction is greater than the width of the laser weld seam measured in the irradiation surface perpendicular to the longitudinal extension of the laser weld seam. In this way—as already explained—a particularly stable laser weld seam with the geometric characteristic of a deep-welded weld seam, but in the method of thermal conduction welding, is produced.

The laser weld seam is particularly preferably produced with a ratio of the depth measured in the irradiation direction to the width (aspect ratio) measured in the irradiation surface perpendicular to the longitudinal extension of the laser weld seam of at least 1 to at most 3. However, it is also possible to produce a laser weld seam in a targeted manner in which the ratio of the depth measured in the direction of irradiation to the width measured in the irradiation surface perpendicular to the longitudinal extension of the laser weld seam, i.e. the aspect ratio, of at least 0.15 to at most 0.5, preferably from at least 0.2 to at most 0.3. With the method disclosed here, such laser weld seams can also be produced in a very stable manner, in particular ductile and tough, with high strength and gas-tight.

According to a further development of the invention, it is intended that the laser beam is shifted several times—in particular one after the other—along the gap relative to the arrangement of the component. In this way it is possible to produce the laser weld seam in several layers. In particular, the laser weld seam is run through several times, or in the case of rotationally symmetrical parts, especially axes, shafts or pipes, with several rotations. In particular, laser welding seams can be produced in this way whose depth measured in the irradiation direction is considerably greater than the width measured in the irradiation region perpendicular to the longitudinal extension of the laser welding seam, whereby a ratio of this depth to the width, also known as the aspect ratio, is preferably greater than 2. Such a large aspect ratio can otherwise only be achieved by deep penetration welding in the known manner, whereas it can also be achieved in the method of heat conduction welding by means of the procedure proposed here.

Alternatively, it is also possible that the laser weld seam is created in one pass, whereby the laser beam is displaced once along the gap relative to the component arrangement.

According to a further development of the invention, it is provided that the laser beam is displaced several times in time succession along the gap relative to the component arrangement, the laser beam being displaced from at least two to at most five times, preferably from at least two to at most four times, preferably from at least two to at most three times, in particular along a same displacement path, along the gap relative to the component arrangement. The weld is thus divided into several partial welds, which allows a very good welding result and especially a very high aspect ratio for the laser weld.

According to a further development of the invention, it is provided that a region of action of the laser beam in which the laser beam interacts with the components is different for at least two displacements of the laser beam along the gap—along the same displacement path. The laser beam is thus displaced several times along the gap relative to the component arrangement, whereby the region of action at least at a first displacement along the gap is different from the region of action of at least a second displacement.

In particular, it is possible that the region of action is selected differently for all displacements of a plurality of such displacements of the laser beam along the gap. In particular, the size of the region of action, preferably a width dimension, especially a diameter of the region of action, is varied.

In particular, the size of the effective region, especially the width or diameter of the effective region, increases from a first displacement to a subsequent displacement of the laser beam, especially successively from each preceding displacement to each subsequent displacement. Especially preferred is the linear increase of the size of the working region.

Preferably, the width dimension, in particular the diameter, of the region of action is smaller than the width of the gap during a first shift of the laser beam of a plurality of shifts, preferably a quotient of the width dimension, in particular the diameter, of the region of action to the gap width of at least 0.3 to at most 0.9. Preferably, the width dimension, in particular the diameter, of the region of action for at least two displacements of a plurality of displacements of the laser beam along the gap is smaller than the gap width, the quotient of the width dimension to the width of the gap being at least 0.3 to at most 0.9. Preferably, the width dimension of the region of action, in particular whose diameter, at a last displacement of a plurality of displacements of the laser beam along the gap, in particular only at the last displacement, is greater than or equal to the width of the gap, the quotient of the width dimension to the width of the gap is preferably from a minimum of 1.0 up to at most 2.0.

A subdivision of the weld into several partial welds, and in particular the beginning of a partial weld with a comparatively small working region and then an increasingly large working region, allows an optimization of the weld quality in an advantageous way. Flow behavior of the material in the gap. The gap is initially widened by the first partial weld—and, if necessary, by further, subsequent partial welds—so that later, especially in subsequent partial welds with a larger working region, melted material above the initially generated widening zone can flow into the widened gap. In this way, particularly large aspect ratios can be achieved for the laser weld seam. In particular, the gap with the first partial weld can be widened or deepened downwards, that is to say in the direction of irradiation.

A varying region of action is created according to a preferred design by varying the beam diameter of the laser beam. In particular, the beam diameter can be the same as the diameter of the working region, and the beam region, which is determined by the beam diameter, is identical to the working region. It is possible that the varying exposure region is generated by a displacement movement of the laser beam superimposed on the displacement along the gap, in particular a so-called sweeping movement, so that the exposure region is larger than the beam diameter due to the displacement movement of the laser beam. In order to increase the effective region, the amplitude of this displacement movement, especially the sweep movement, can be increased. In particular, the displacement movement for varying the region of action has a higher displacement speed than the displacement of the laser beam along the gap, so that a desired region of action is generated quasi instantaneously at a location of the gap by the displacement motion superimposed on the displacement of the laser beam along the gap, in particular the sweeping motion.

According to a further development of the invention it is provided that the power of the laser beam at a first displacement of the laser beam along the gap is different from the power of the laser beam at a second displacement of the laser beam along the gap when the laser beam is shifted several times along the gap—especially along the same displacement path. The power is preferably varied from displacement to displacement. In particular, the power preferably increases from each preceding displacement of a plurality of displacements to a subsequent displacement of the plurality of displacements. Preferably the variation of the power is chosen in such a way that there is a constant power density in the respective regions of action. Thus, the flat power or power density can be kept advantageously constant over the successive displacements.

According to a further development of the invention, it is intended that a thin-walled component with a wall thickness of at least 0.1 mm up to at most 4 mm, preferably of at least 0.2 mm up to at most 3 mm, is used as the first component and/or as the second component. The method proposed here is particularly suitable for welding thin-walled components, especially for precision mechanical applications. The thin-walled component can preferably be a sheet or a pipe.

A thin-walled component, in particular sheet metal, with a wall thickness of at least 0.1 mm up to at most 4 mm, preferably of at least 0.2 mm up to at most 3 mm, is used particularly preferably as the first component, wherein a component with a greater wall thickness than the first component, in particular with a wall thickness of more than 3 mm, in particular sheet metal, is used as the second component. The method proposed here is particularly suitable for joining components of different thickness or thickness.

According to a further development of the invention, it is intended that a thin-walled tube with a wall thickness of at least 0.1 mm up to at most 4 mm, preferably of at least 0.2 mm up to at most 3 mm, is used as the first component and/or as the second component. A thin-walled tube with a wall thickness of at least 0.1 mm up to at most 4 mm, preferably at least 0.2 mm up to at most 3 mm, is particularly preferred as the first component, with a flange being used as the second component. The method proposed here is particularly suitable for connecting thin-walled pipes with flanges, especially those with comparatively thick walls. According to a particularly preferred design of the method, at least one thin-walled component, in particular with a wall thickness of at least 0.1 mm up to at most 4 mm, preferably at least 0.2 mm up to at most 3 mm, is welded to another component without the use of a filler material.

The method is preferably used for welding at least one precision mechanical component without filler material to another, preferably also precision mechanical component.

In general, the method is preferably used for components that have oxidation-sensitive material or consist of at least one oxidation-sensitive material.

With the help of this method, smooth, clean welding seams can be produced without spatter. The method is particularly preferred for producing gas-tight welding seams on thin-walled pipes in circumferential direction.

Finally, the task is solved by creating a component arrangement that has a first component and a second component, whereby the first component and the second component are joined with one

another by means of laser hot run welding, whereby a Laser weld seam in a joint region of the component arrangement preferably has a depth which is greater than its width, the corresponding aspect ratio being greater than 1, preferably at least 2, preferably being greater than 2 preferably at most 3. However, a laser weld seam with an aspect ratio of at least 0.15 to 0.5 at the most, and in particular of at least 0.2 to 0.3 at the most, can also be produced in an alternative method. In the way described here, a very stable, especially under pressure gas-tight laser weld seam is produced in the method of the hot conduction welding without the risk of seam contamination by oxidation products, spatter or welding spores. In particular, the advantages already mentioned in connection with the method result in connection with the component arrangement.

The fact that the laser weld seam in the joint region of the component arrangement has a certain aspect ratio can be seen especially in cross-sectional micrographs of the component arrangement.

The component arrangement is preferably obtained by means of a inventive method or a method according to one of the previously described forms of execution.

It is provided that at least one component, selected from the first component and the second component, is designed as a sintered component, in particular as a sintered component manufactured by an additive method or as a MIM component, i.e. as a component manufactured by a metal powder injection molding method. As already explained, the advantages of the method are particularly evident in this case. In the method of hot wire welding, no residual binder components of such a MIM component are oxidized, although the method can still produce stable laser welding seams, especially gas- and pressure-tight ones. In general, residual gas components in pores of sintered components has a negative effect on the weld if the welding method disclosed here is used.

Especially preferred are both components, namely the first component and the second component, as sintered components.

Preferably, the first component is a spring hinge housing for a pair of spectacles, which is designed as a MIM component is manufactured, and the second component is a spectacle bow, which has INOX, in particular consists of INOX. In this case in particular, a weld seam can be obtained which has the optical appearance and/or quality of a soldered seam.

According to a further training of the invention, it is provided that at least one component selected from the first component and the second component indicates a copper or a copper alloy, or consists of copper or a copper alloy. These materials can be especially good at a wavelength of 532 nm, 515 nm or 450 nm laser welding. In connection with copper or a copper alloy, the advantages of the method disclosed here are realized in a special way, especially if a green or blue laser beam, preferably with a wavelength of 532 nm, 515 nm or 450 nm is used. The multiple reflections in the gap have a particularly advantageous effect, whereby the method of heat conduction welding in particular can be extended to greater seam depths and also used for thin walls.

All in all, the method disclosed here can be used to produce tough, high-quality welds that are oxide-free and, in particular, do not show any signs of deterioration. The Welding can also be carried out without distortion, tarnish and smoke. A strength of the connection between the two components in the region of the weld seam of more than 250 N can be advantageously achieved.

The invention is explained more closely in the following on the basis of the drawing.

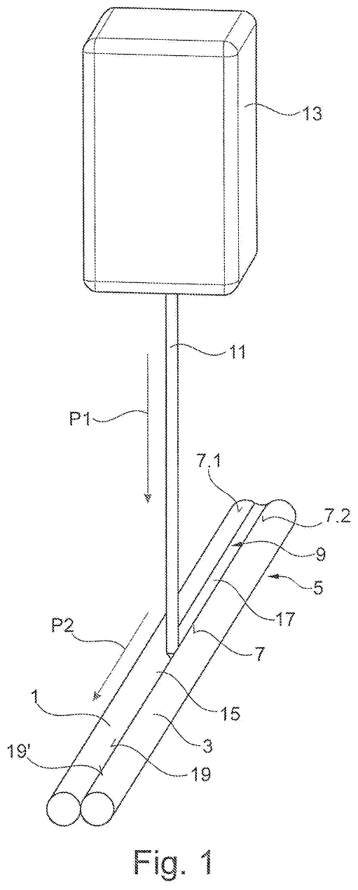

FIG. 1 a schematic representation of a first form of a method for joining two components with one another by laser welding;

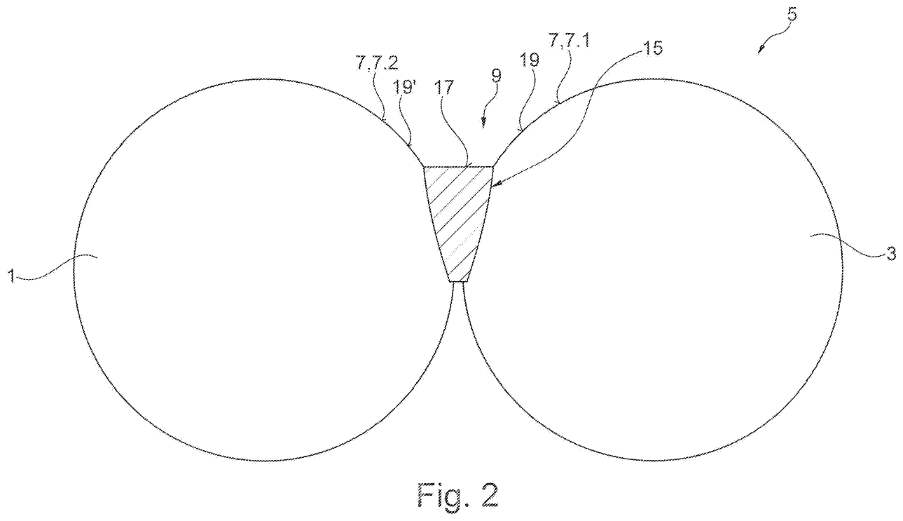

FIG. 2 is a schematic representation of an example of the execution of an arrangement of two components joined with one another by laser heat conduction welding;

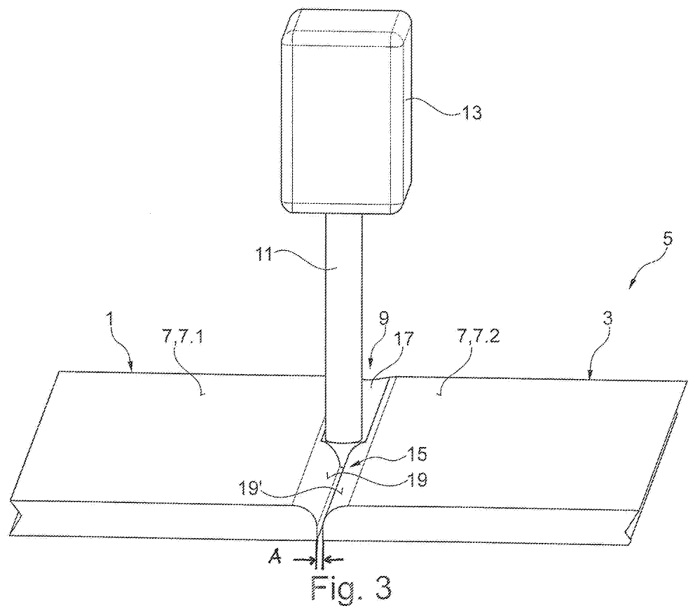

FIG. 3 a schematic representation of a second type of method;

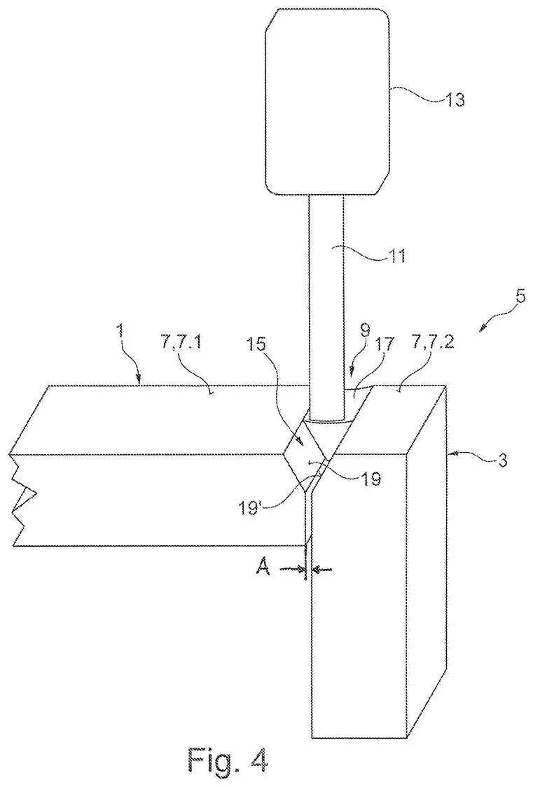

FIG. 4 a schematic representation of a third type of the method;

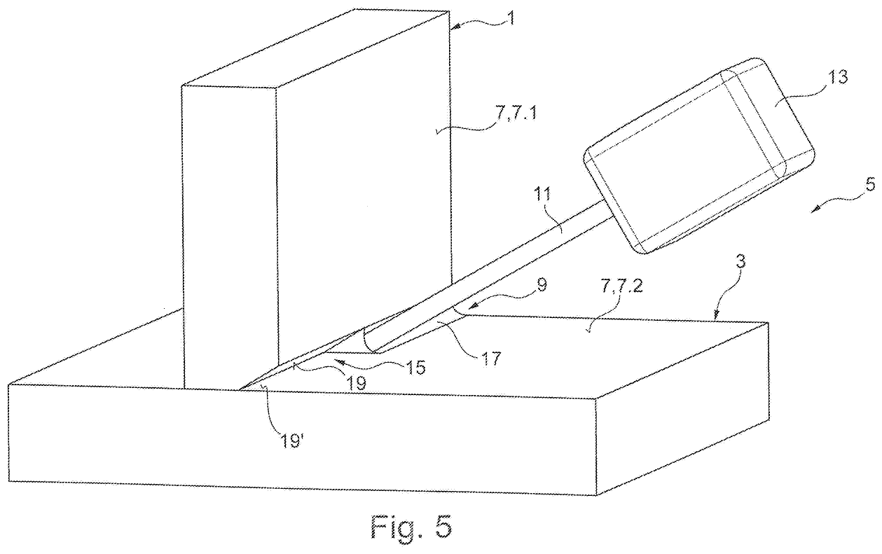

FIG. 5 a schematic representation of a fourth form of the method, and

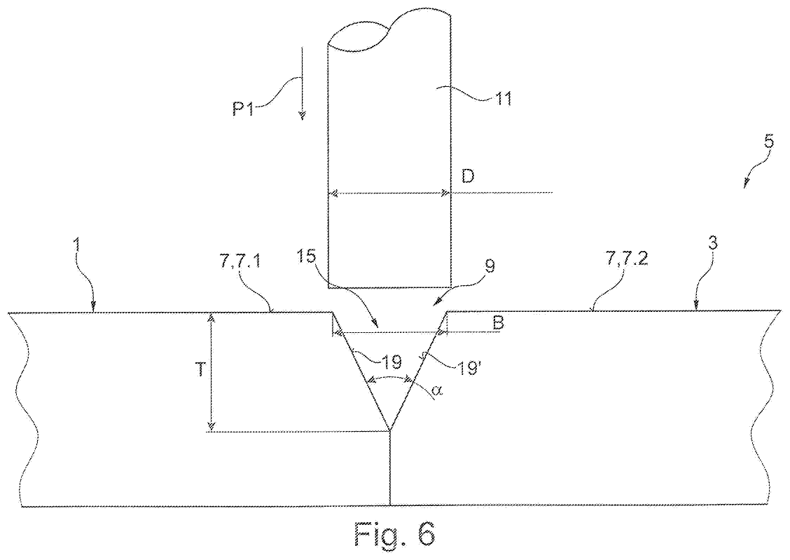

FIG. 6 is a schematic representation of a fifth form of the method.

FIG. 1 shows a schematic representation of a method for welding two components with one another by laser welding, whereby a first component and a second component 3 are arranged adjacent to each other to form a component arrangement 5 in such a way that the component arrangement 5 has an irradiation surface 7 which has a first irradiation sub-surface 7.1 on the first component 1 and a second irradiation sub-surface 7.2 on the second component 3. The irradiation surface 7 is irradiated with a laser beam 11 in a joint region 9 along the irradiation direction indicated by a first arrow P1. The laser beam 11 is generated by a laser beam source 13, in particular a laser is provided. The laser beam source 13 can also be a last outcoupling unit, for example of an optical fiber carrying the laser beam 11, a last mirror, or another beam carrying or beam deflecting optical element before the joint region 9, from which the laser beam 11 propagates freely to the joint region 9. The irradiation direction extends from the laser beam source 13 in the direction of the joint region 9.

The laser beam 11 is preferably moved relative to the component arrangement 5 along a longitudinal extension of the laser weld seam to be produced. Alternatively or additionally, the component assembly 5 can be moved relative to the—if necessary stationary—laser beam 11.

The irradiation surface 7 has a gap 15 in the joint region 9 that narrows from the irradiation surface 7 in the irradiation direction. The first component 1 and the second Component 3 are joined with one another by heat conduction welding.

In this way it is possible to form a stable, embrittlement free, especially oxide-free, laser weld seam 17, whose geometry is essentially determined by the geometry of the gap 15. In particular, the laser weld seam 17 can be produced with a depth that is greater than its width measured in the irradiation surface 7, in particular also with an aspect ratio of greater than 2. The depth of the laser weld seam 17 extends from the irradiation surface 7 into the gap 15 as seen in the direction of irradiation.

In the method design shown here, the gap 15 is symmetrically formed on the first component 1 and on the second component 3. The gap 15 has at least one rounded wall 19, 19′. In particular, the gap 15 has two rounded walls 19, 19′.

In particular, the components 1, 3 here are designed as wires, especially as circular cylindrical wires, which are arranged next to each other along their longitudinal extension, so that they at best—if they lie close with one another—have line contact with each other. But they can also be arranged at a small distance from each other. The method described here is advantageous in that the gap 15 between the diodes is filled by material melted from their surfaces without the molten material escaping on the side facing away from the laser beam source 13. In this way, a very clean, stable and at the same time aesthetically pleasing attachment of the two wires to each other can be achieved. Especially an optical quality like soldered seam can be achieved.

FIG. 2 shows a schematic representation of an example of a component assembly 5, in particular the component assembly 5 produced within the scope of the method according to FIG. 1. Identical and functionally identical elements are marked with identical reference marks, so that reference is made to the previous description. FIG. 2 shows in particular a Cross-sectional view of the component arrangement 5, as it is typically obtained for a micrograph to assess the quality of the laser weld seam 17. The first component 1 and the second component 3 are welded with one another by means of laser heat conduction welding the laser weld seam 17 in the joint region 9 of the component arrangement 5 has a depth that is greater than its width.

FIG. 2 also shows that the material melted from the surfaces and in particular the walls 19, 19′ of the gap 15 fills the gap 15 without affecting the laser beam source 13 or, here, the laser weld seam 17 to get away from the side of the component assembly 5.

At least one of the components 1, 3 is preferably manufactured or designed as a sintered component, in particular as an MIM component. Both components 1, 3 are particularly preferably manufactured or designed as sintered components, in particular as MIM components. In doing so, in particular there are advantages of the method, since in the method of hot conduction welding 30 no interference from residual gas from pores and no oxidation of residual binder components is to be feared. At the same time, a very stable laser weld seam 17 can be produced.

For the fillet shape according to FIG. 1 of the method and the fillet example according to FIG. 2 of the component arrangement 5, a wire diameter for components 1, 3 of at least 1.0 mm up to at most 5.0 mm, preferably 1.3 mm, is particularly used. A width of the laser weld seam 17 measured in the irradiation region 7 is 5 preferably from at least 0.2 mm to at most 3 mm, preferably 0.4 mm.

It is possible that the laser beam 11 is generated in CW mode. Especially in this case, the feed rate along a longitudinal extension of the laser weld seam 17 shown in FIG. 1 by a second arrow P2 is preferably from at least 5 m/min to at most 15 m/min, preferably 12 m/min. The laser power of the laser beam 11 is preferably from at least 250 W to at most 5 kW, preferably 750 W.

The laser beam 11 is preferably generated with a wavelength of at least 400 nm to at most 1200 nm, preferably from at least 920 nm to at most 1064 nm, especially 532 nm, 515 nm or 450 nm.

It is also possible that the laser beam 11 is generated in a pulsed mode.

In particular, it is possible to irradiate the irradiation surface 7 by the laser beam 11 in a pulsed operation or in a continuous operation.

The laser beam 11 is preferably generated with a beam diameter of at least 0.2 mm to at most 2.5 mm, especially preferably of 0.4 mm.

The laser beam 11 is preferably generated by a laser selected from a group consisting of a diode laser, a fiber laser, a Nd:YAG laser, and a disk laser, in particular a diode-pumped disk laser.

At least one component, selected from the first component 1 and the second component 3, preferably has a material or consists of a material selected from a group consisting of nickel silver, stainless steel, in particular stainless steel 316L, copper

or a copper alloy, and titanium. in what is particularly preferred, both components 1, 3 have such a material or consist of such a material.

FIG. 3 shows a schematic representation of the second type of method.

Identical and functionally identical elements are marked with identical reference signs, so that reference is made to the previous description. The components 1, 3 are here designed as sheets, whereby the gap 15 has two rounded walls 19, 19′ each. The rounded walls 19, 19′ can have different radii or the same radius.

Preferably at least one radius of one of the rounded walls 19, 19′ of at least 0.1 mm to at most 5 mm; preferably of at least 0.3 mm to at most 5 mm; preferably of at least 0.3 mm to at most 4.5 mm, preferably of at least 4 mm; preferably of at least 3.5 mm; preferably of at most 3.5 mm; preferably of at least 3 mm; preferably of at least 2.7 mm; preferably of at least 0.4 mm to at most 2.6 mm; preferably of at least 0.5 mm up to at most 2.5 mm; preferably from at least 0.6 mm up to at most 2.4 mm; preferably from at least 0.7 mm up to at most 2.3 mm; preferably from at least 0.8 mm up to at most 2.2 mm; preferably from at least 0.9 mm up to at most 2.1 mm; preferably from at least 1.0 mm to at most 2.0 mm; preferably from at least 1.1 mm to at most 1.9 mm; preferably from at least 1.2 mm to at most 1.8 mm; preferably from at least 1.3 mm to at most 1.7 mm; preferably from at least 1.4 mm to at most 1.6 mm; preferably from 1.5 mm, preferably 0.65 mm.

The components 1, 3 are arranged here in particular at a distance A, in particular a minimum distance A, from one another, which is from at least 0 mm to at most 0.3 mm, preferably to at most 0.25 mm, preferably to at most 0.2 mm, preferably to at most 0.1 mm, preferably at least 0.01 mm, preferably at least 0.05 mm. If preferred, distance A is selected specifically in this region.

FIG. 4 shows a schematic representation of a third type of execution of the method. Identical and functionally identical elements are provided with identical reference marks, insofar as reference is made to the previous description. The components 1, 3 are arranged over the corner and therefore perpendicular to each other. The gap 15 has at least one flat sloped wall, here two sloped walls in the form of the sloped walls 19, 19′. These are preferably provided by chamfering the components 1, 3 accordingly. In the example shown here, the gap is symmetrical to the first component 1 and formed on the second component 3.

FIG. 5 shows a schematic representation of the fourth execution form of the method. Identical and functionally identical elements are provided with identical reference signs, insofar as reference is made to the previous description. While in the previously shown figures the irradiation sub-surfaces 7.1, 7.2 were arranged parallel to each other and aligned with each other in the shapes and examples shown there, in the example shown in FIG. 5 they are now arranged over the corner, in particular at an angle of 90° to each other, so that the irradiation surface 7 is not flat.

The gap 15 is formed here on one side of one of the components 1, 3—here on the first component 1—and has only one flat sloping wall, namely the first wall 19, which is formed as a chamfer. The second wall 19′ of gap 15 is formed here without any chamfer or chamfer by the flat, second irradiation partial surface 7.2 of the second component 3.

The gap 15 is designed in particular as a fillet weld.

FIG. 6 shows a schematic representation of a fifth form of the method. Identical and functionally identical elements are marked with identical reference signs, so that reference is made to the previous description. The following parameters are schematically shown here: A beam width dimension B or diameter D of the laser beam 11, a width B of the gap 15 measured in the irradiation surface 7 perpendicular to the longitudinal extension of the laser weld seam 17, a width B of the gap 15 measured in the irradiation direction starting from Irradiation surface 7 measured depth T of gap 15, and a full opening angle a of gap 15.

Preferably a quotient of the beam diameter D to the width B of the gap 15 of at least 0.2 to at most 2.0; preferably of at least 0.3 to at most 2.0; preferably of at least 0.4 to at most 2.0; preferably of at least 0.5 to at most 2.0; preferably of at least 0.6 to at most 1.9; preferably from at least 0.7 to at most 1.8; preferably to at most 1.7; preferably to at most 1.6; preferably from at least 0.8 to at most 1.5; preferably from at least 0.9 to at most 1.4; preferably from at least 1.0 to at most 1.3; preferably 1.2.

The full opening angle a of the gap 15 is preferably from at least 15° to at most 60°; preferably from at least 20° to at most 55°; preferably from at least 30° to at most 45°; preferably from at least 35° to at most 40°; preferably 37°.

A quotient of the depth T of the gap 15 to its width B is preferably at least 0.2, preferably at least 0.3, preferably at least 0.5, preferably at least 0.6 to at most 3.2; preferably from at least 0.7 to at most 3.1; preferably from at least 0.8 to at most 3.0; preferably from at least 0.9 to at most 2.9; preferably from at least 1.0 to at most 2.8; preferably from at least 1.2 to at most 2.6; preferably from at least 1.4 to at most 2.4; preferably from at least 1.6 to at most 2.2; preferably from at least 1.8 to at most 2.0; preferably 1.9.

A width of the laser weld seam 17 measured in the irradiation surface 7 perpendicular to the longitudinal extension of the laser weld seam 17 is preferably from at least 0.1 mm to at most 3 mm; preferably from at least 0.2 mm to at most 0.8 mm; preferably from at least 0.3 mm to at most 0.7 mm; preferably from at least 0.4 mm to at most 0.6 mm; preferably 0.5 mm or 0.4 mm.

It is possible for the laser beam 11 to be displaced once or several times—in particular 15 consecutively in time—along the gap 15 relative to the component arrangement 5. In the case of a multiple displacement along the same displacement path along the gap 15, a variation of an region of action of the laser beam 11 on the components 1, 3—in particular by a variation of a wobbling movement superimposed on the displacement along the gap 15 and/or by varying the beam diameter D—be provided. In particular, the region affected can increase from displacement to displacement. As an alternative or in addition, a variation of the power of the laser beam 11 in the event of a multiple shift, in particular from shift to shift, can be provided. A surface power or power density of the laser beam is preferably kept constant in the—preferably varying—effective surface.

In a specific exemplary embodiment, it is possible for the laser beam 11 to have an effective region with a diameter of 0.15 mm during a first displacement along the gap 15, the effective region for a second displacement along the same displacement distance has a diameter of 0.3 mm and a third displacement has a diameter of 0.5 mm. The surface power or power density of the laser beam 11 is preferably kept constant.

Preferably, the first component and the second component are joined with one another without any filler material and/or protective gas. Preferably, at least one of the components 1, 3 is a precision mechanical component. In this case, it is preferable to join the components 1, 3 without any filler material or inert gas.

In cyclic operation, the feed rate is preferably at least 0.25 m/min, preferably from at least 0.5 m/min to at most 3 m/min, preferably to at most 1 m/min; in continuous operation, it is preferably from at least 3 m/min to at most 30 m/min.

In total, the method proposed here can be used to produce a stable, geometrically precisely defined laser weld seam 17 in the hot conduction welding method, whereby the component arrangement 5 proposed here is characterized by a correspondingly stable and embrittlement free laser weld seam 17.

1. A method of joining two components to one another by laser welding, the method comprising:
arranging a first component and a second component adjacent to one another in a component arrangement such that
the component arrangement has an irradiation surface comprising a first partial irradiation surface on the first component and a second irradiation partial surface on the second component; and
irradiating the irradiation surface with a laser beam along an irradiation direction in a joining region,
wherein
the irradiation surface has a gap in the joining region which, starting from the irradiation surface, tapers in the irradiation direction, and
wherein the first component and the second component are joined to one another by heat conduction welding.

2. The method according to claim 1, wherein the component arrangement is provided by arranging the first component and the second component at a distance from one another which is from at least 0 mm to at most 0.3 mm.

3. The method according to claim 1, wherein a minimum distance between the first component and the second component in the joining region is at least 0 mm to at most 0.3 mm.

4. The method according to claim 1, wherein the first component and the second component are joined to one another
a) without an additional active substance, and/or
b) without inert gas.

5. The method according to claim 1, wherein a quotient of a beam width dimension of the laser beam is added to a beam width dimension in the irradiation surface measured width of the gap is at least 0.2 to at most 2.0.

6. The method according to claim 1, wherein the gap is:
a) symmetrical on the first component and on the second component, or
b) on one side of a component selected from the first component and the second component;
and/or in that the gap is formed
c) at least one rounded wall, and/or
d) at least one flat sloping wall.

7. The method according to claim 1, wherein
a) at least one rounded wall has a radius of at least 0.1 mm to at most of 5 mm; and/or
b) a full opening angle of the gap having at least one sloping wall is at least 15° to at most 60°; preferably at least 20° to at most 55°; and/or
c) a quotient of a radiation intensity in the direction of irradiation from the irradiation region measured depth of the gap to the width of the gap measured in the irradiation region of at least 0.2.

8. The method according to claim 1, wherein the laser beam
a) in a CW mode; or
b) in a pulsed mode; and/or
c) with a beam diameter of at least 0.1 mm and not more than 2.5 mm, and/or
d) with a power output of not less than 50 W and not more than 5 kW and/or
e) with a wavelength of 400 nm or more but not exceeding 1200 nm, and/or
f) with a feed rate of at least 0.25 m/min in a clocked operation with a feed rate of at least 0.25 m/min.

9. The method according to claim 1, wherein the laser beam is generated by a laser selected from a group consisting of a diode laser, a fiber laser, a Nd:YAG laser, and a disk laser.

10. The method according to claim 1, wherein at least one component selected from the first component and the second component:
a) has at least one material or consists of a material selected from a group consisting of nickel silver, INOX, in particular INOX 316L, copper or a copper alloy, and titanium, and/or
b) is manufactured as a sintered component, in particular as an additive manufactured sintered component or as a MIM component.

11. The method according to claim 1, wherein a laser weld seam is produced, wherein:
a) one in the irradiation surface perpendicular to the longitudinal extension of the laser weld seam measured width of the laser weld seam of at least 0.1 mm to at most 3 mm, and/or
b) a depth of the laser weld seam measured in the irradiation direction is greater than that in the irradiation surface perpendicular to the longitudinal extension of the laser weld seam, measured width of the laser weld seam.

12. The method according to claim 1, wherein the laser beam is displaced several times along the gap relative to the component arrangement.

13. The method according to claim 1, wherein at least one of the first component and the second component is a tube, with a wall thickness of at least 0.1 mm to at most 4 mm.

14. A component arrangement comprising:
a first component and a second component, the first component and the second component welded to one another by laser heat conduction welding, wherein:
a) a laser weld seam in a joining region of the component arrangement has a depth which is greater than its width, and/or
b) at least one component, selected from the first component and the second component, is a sintered component or is formed as MIM component.

15. The component arrangement according to claim 14, wherein at least one component selected from the first component and the second component exhibits copper or a copper alloy, or consists of copper or a copper alloy.
